(19) United States
(12) Patent Application Publication
(10) Pub. No.: US 2024/0385011 A1
(43) Pub. Date: Nov. 21, 2024

(54) NAVIGATION DEVICE

(71) Applicant: TOYOTA JIDOSHA KABUSHIKI KAISHA, Toyota-shi (JP)

(72) Inventors: Kohei MIWA, Sunto-gun (JP); Makoto MATSUSHITA, Ichinomiya-shi (JP); Yuko MIZUNO, Nagoya-shi (JP); Hayato MIZUMA, Tokyo (JP); Naoki YAMADA, Kasugai-shi (JP)

(73) Assignee: TOYOTA JIDOSHA KABUSHIKI KAISHA, Toyota-shi (JP)

(21) Appl. No.: 18/599,478

(22) Filed: Mar. 8, 2024

(30) Foreign Application Priority Data
May 18, 2023 (JP) 2023-082196

(51) Int. Cl. G01C 21/00

(52) U.S. Cl. CPC G01C 21/3811; G01C 21/3837

(57) ABSTRACT

A navigation device for a vehicle equipped with a drive recorder includes a processing device and a storage device that stores map information. The processing device acquires shop information, which is shop information written on the signboard photographed by the drive recorder, and if the acquired shop information is not registered in the map information, the shop information is stored in the map information. Execute the process to add to.

### CROSS-REFERENCE TO RELATED APPLICATION

This application claims priority to Japanese Patent Application No. 2023-082196 filed on May 18, 2023, incorporated herein by reference in its entirety.

### BACKGROUND

### 1. Technical Field

The present disclosure relates to a navigation device.

### 2. Description of Related Art

Japanese Unexamined Patent Application Publication No. 2022-77296 (JP 2022-77296 A) discloses a navigation system. This navigation system includes a navigation device mounted on a vehicle. A storage device of the navigation device stores map information including shop information.

### SUMMARY

When adding, to the map information, information on a new shop that is not registered in the map information, for example, an occupant of the vehicle may manually register the map information. As an alternative method, after the shop information registered in a data center is updated, the new shop information may be acquired via a network and registered in the navigation device. However, the manual registration of the map information is time-consuming. When acquiring the new shop information via the network, the new shop information cannot be acquired until the shop information registered in the data center is updated. Therefore, there is a demand to improve the convenience when adding, to the map information, information on a shop that is not registered in the map information.

A navigation device for solving the above problems is a navigation device for a vehicle including a drive recorder. The navigation device includes a processing device and a storage device that stores map information. The processing device is configured to:
acquire shop information that is information on a shop shown on a signboard imaged by the drive recorder; and
when the acquired shop information is not registered in the map information, add the shop information to the map information.

This navigation device can improve the convenience when adding, to the map information, information on a shop that is not registered in the map information.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing the configuration of a navigation system according to an embodiment; and

FIG. 2 is a flowchart showing a processing procedure executed by a processing device included in the navigation device.

### DETAILED DESCRIPTION OF EMBODIMENTS

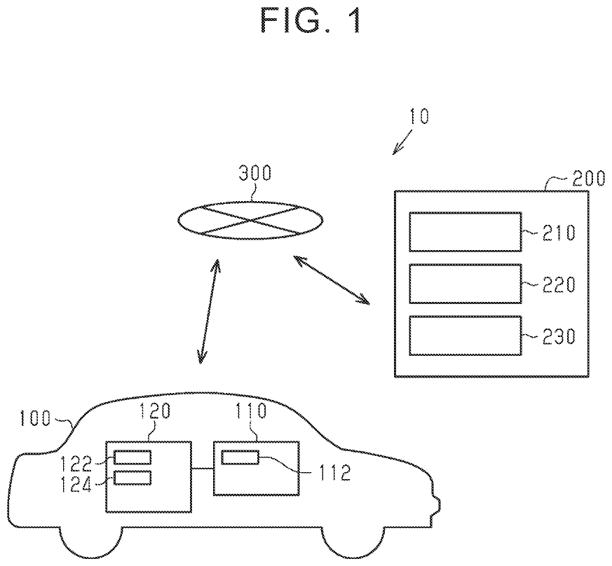

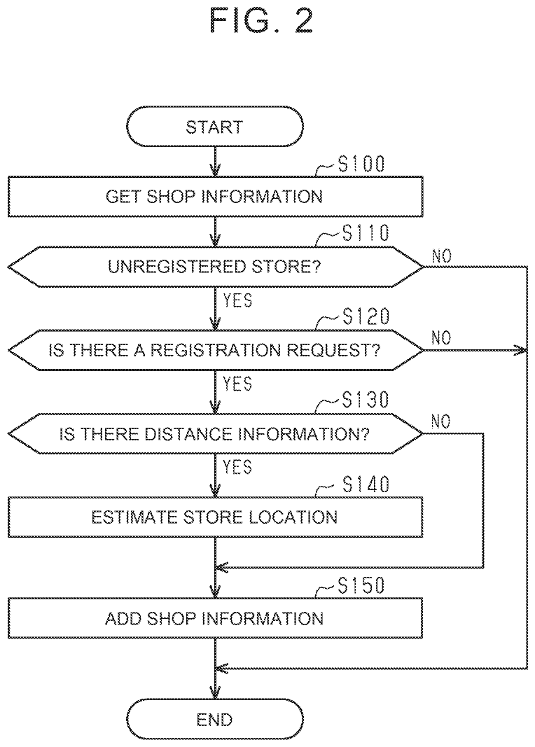

Hereinafter, one embodiment of a navigation device will be described with reference to FIGS. 1 and 2.

### Navigation System Configuration

As shown in FIG. 1, the navigation system 10 includes a vehicle 100 and a data center 200. Data center 200 is communicably connected to a plurality of vehicles 100 via communication network 300. Each vehicle 100 includes a drive recorder 110 and a navigation device 120.

The drive recorder 110 captures and records an image of the front of the vehicle that can be seen from the driver's seat. The drive recorder 110 also includes a processing device 112 that executes various processes by executing programs stored in a ROM or the like. Note that the processing device 112 includes a processor. The processing device 112 performs image analysis on, for example, a captured video. For example, if a signboard is included in the captured video, the processing device 112 extracts shop information, which is information about the store written on the signboard, by analyzing the video of the signboard. The extracted shop information is the store name. Furthermore, if the distance to the store is written on the signboard, the extracted shop information is the store name and the distance to the store. Then, the final shop information is generated by adding the store image of the signboard taken by the drive recorder 110 to the extracted shop information.

The navigation device 120 includes a satellite positioning system receiver, a communication device, a display, an input device, a storage device 122 storing data such as map information, and a processing device 124. The processing device 124 includes a processor, and executes various processes by executing programs stored in a ROM or the like.

Drive recorder 110 and navigation device 120 are connected so that they can exchange information with each other.

The data center 200 includes a storage device 220 that stores programs, and a processing device 210 that executes the programs stored in the storage device 220 to perform various processes. Note that the processing device 210 includes a processor.

The data center 200 includes a communication device 230. The communication device 230 is implemented as hardware such as a network adapter, various communication software, or a combination thereof. The communication device 230 is configured to implement wired or wireless communication via the communication network 300. Data center 200 may be configured using multiple computers. For example, the data center 200 may be configured with a plurality of server devices.

### Processes Performed by Navigation Devices

FIG. 2 shows a processing procedure executed by the processing device 124 included in the navigation device 120. Note that this process is executed when the drive recorder 110 generates the above shop information. Further, in the following, the step number of each process will be expressed by a number prefixed with “S”.

When this process is started, the processing device 124 acquires the shop information generated by the drive recorder 110 (S100).

Next, the processing device 124 determines whether the acquired shop information is an unregistered store (S110). An unregistered store is a store that is not registered in the current map information stored in the storage device 122. In the process of S110, for example, if the store name included in the acquired shop information is not included in the shop information written in the map information near the current location of the vehicle 100, the processing device 124 uses the acquired shop information. is determined to be an unregistered store.

When determining that the acquired shop information is an unregistered store (S110: YES), the processing device 124 determines whether there is a request to register an unregistered store (S120). In the process of S120, for example, the processing device 124 displays a message on the display of the navigation device 120 to request an answer as to whether to register the unregistered store. In response to this inquiry, if the driver or the like performs an operation indicating an intention to register, the processing device 124 determines that there is a request to register an unregistered store. On the other hand, if the driver or the like performs an operation indicating an intention not to register, the processing device 124 determines that there is no request for registration of an unregistered store.

In the process of S120, if it is determined that there is a request to register an unregistered store (S120: YES), the processing device 124 determines whether the acquired shop information includes distance information (S130). The distance information is the distance to the store listed on the signboard.

In S130, if it is determined that there is distance information (S130: YES), the processing device 124 estimates the store location based on the current location information of the vehicle 100 and the distance information (S140).

After executing the process of S140 or after a negative determination is made in the process of S130, the processing device 124 executes a process of adding shop information (S150). In the process of S150, the processing device 124 adds shop information to the map information stored in the storage device 122. The added shop information includes a store name, an image of the store, and location information indicating the location of the store. Note that if an affirmative determination is made in the process of S130, the location information of the estimated store location is added to the map information as location information indicating the location of the store. On the other hand, if a negative determination is made in the process of S130, the location information of the vehicle 100 when the drive recorder 110 photographed the signboard is added to the map information as location information indicating the location of the store. Further, in this embodiment, when adding shop information to map information, point registration is performed, but shop information may be written in the map data itself.

When the processing of S150 is completed, or when a negative determination is made in the processing of S110 or S120, the processing device 124 ends this processing.

### Action and Effect

The operation and effects of this embodiment will be explained.
(1) The processing device 124 acquires shop information, which is shop information written on the signboard photographed by the drive recorder 110. Then, if the acquired shop information is not registered in the map information, the processing device 124 executes a process of adding the shop information to the map information. Therefore, when information about a store that is not registered in the map information is photographed by the drive recorder 110, the shop information is added to the map information. Therefore, it becomes more convenient to add information about stores that are not registered in the map information to the map information.
(2) If the shop information includes the distance to the store, the processing device 124 adds the estimated store position based on the distance to the map information. Therefore, even if the vehicle 100 does not pass in front of a store, information about a store that is not registered in the map information can be added to the map information.
(3) The shop information added to the map information includes a store name, store location information, and an image of the store captured by the drive recorder 110. Therefore, compared to the case where the shop information does not include a store image, the convenience of checking the shop information added to the map information is improved.

### Example of Change

This embodiment can be modified and implemented as follows. This embodiment and the following modified examples can be implemented in combination with each other within a technically consistent range.

The navigation device 120 inquires of the driver or the like whether to register an unregistered store. If the driver or the like approves the registration, the navigation device 120 adds shop information of the unregistered store to the map information. On the other hand, the navigation device 120 may be configured to add shop information of unregistered stores to map information without requiring permission from the driver or the like.

Although the shop information included an image of the store taken by the drive recorder 110, this store image may be omitted.

The navigation device 120 estimated the store location when the acquired shop information included distance information. However, such processing related to estimating the store location may be omitted.

The navigation device 120 added shop information of unregistered stores to the map information stored in the storage device 122 of the navigation device 120. In addition, the navigation device 120 may upload shop information of unregistered stores to the data center 200.

The processing device 124 is not limited to one that includes a processor and a ROM and executes software processing. For example, a dedicated hardware circuit such as an ASIC may be provided to process at least a part of what was processed by software in the above embodiments by hardware. That is, the processing device may have any of the following configurations (a) to (c). (a) It includes a processing device that executes all of the above processing according to a program, and a program storage device such as a ROM that stores the program. (b) It includes a processing device and a program storage device that execute part of the above processing according to a program, and a dedicated hardware circuit that executes the remaining processing. (c) A dedicated hardware circuit is provided to execute all of the above processing. Here, the number of software execution devices including a processing device and a program storage device, or a dedicated hardware circuit may be one or more than one. That is, the processing described above may be performed by a processing circuit comprising at least one of one or more software execution devices and one or more dedicated hardware circuits. Program storage devices or computer readable media include any available media that can be accessed by a general purpose or special purpose computer.

What is claimed is:

1. A navigation device for a vehicle including a drive recorder, the navigation device comprising a processing device and a storage device that stores map information, wherein the processing device is configured to:
acquire shop information that is information on a shop shown on a signboard imaged by the drive recorder; and
when the acquired shop information is not registered in the map information, add the shop information to the map information.

2. The navigation device according to claim 1, wherein the processing device is configured to, when the shop information includes a distance to the shop, add a location of the shop estimated based on the distance to the map information.

3. The navigation device according to claim 1, wherein the shop information added to the map information includes a shop name and location information on the shop.

4. The navigation device according to claim 1, wherein the shop information added to the map information includes a shop name, location information on the shop, and an image of the shop captured by the drive recorder.
